(19) United States
(12) Patent Application Publication
(10) Pub. No.: US 2017/0368560 A1
(43) Pub. Date: Dec. 28, 2017

(54) CENTRIFUGE CONTAINER ADAPTER AND RELATED ARTICLES, SYSTEMS, AND METHODS

(71) Applicant: Flotek Chemistry, LLC, Marlow, OK (US)

(72) Inventors: Grant McElhany, Houston, TX (US); James Silas, College Station, TX (US); Grant Goodwin, Sugar Land, TX (US)

(73) Assignee: Flotek Chemistry, LLC, Marlow, OK (US)

(21) Appl. No.: 15/193,408

(22) Filed: Jun. 27, 2016

(51) Int. Cl. B04B 7/12

(52) U.S. Cl. CPC B04B 7/12

(57) ABSTRACT

The present disclosure generally provides centrifuge container adapters configured to be used in a centrifuge, e.g., a bench-top centrifuge, and centrifuge systems and methods incorporating the centrifuge container adapters. The centrifuge container adapter may receive a centrifuge container, comprising a sample, the sample, in turn, comprising a fluid. During a centrifuging operation, according to some embodiments, the centrifuge container adapter and centrifuge container may be placed in a rotor cavity in the centrifuge. As a rotor of the centrifuge spins, the fluid may exit the sample within the centrifuge container and be collected in a void space of the centrifuge container adapter. In some embodiments, measurements of the fluid in the centrifuge container adapter may be used to determine characteristics or properties of the sample.

### FIELD OF INVENTION

The present invention generally relates to centrifuge container adapters and related articles, systems, and methods.

### BACKGROUND OF INVENTION

A centrifuge is a device that applies force to a sample held in a centrifuge container by rotating the container around a central axis. Centrifuges are available in different sizes. Smaller models may be operated while resting on a bench-top, while large models may stand on a floor. Centrifuges may be used to separate substances, for example, fluids and suspended solids, in a sample mixture or to better understand properties of a sample.

### SUMMARY OF INVENTION

Centrifuge container adapters configured to be used in a centrifuge (e.g., a benchtop centrifuge) and articles, centrifuge systems and methods incorporating the centrifuge container adapters are generally provided.

According to one or more embodiments, a series of articles and systems are provided. In one or more embodiments, a centrifuge container adapter is disclosed. The centrifuge container adapter may be configured to be received into a centrifuge. The centrifuge container adapter may comprise a sidewall, a bottom end, a top end, and a collar. The sidewall may comprise a flared portion and a vertical portion, wherein the vertical portion is located above the flared portion. The bottom end and the sidewall may define a hollow region. At the top end, the sidewall may further define an opening of the hollow region. The collar may surround the vertical portion of the sidewall.

In one or more embodiments a centrifuge system is disclosed. The centrifuge system may comprise a centrifuge. The centrifuge may comprise a rotor configured to rotate around a central axis. The rotor may comprise a rotor cavity.

The centrifuge system may further comprise a centrifuge container adapter. The centrifuge container adapter may be configured to be received into the rotor cavity. The centrifuge container adapter may have a hollow region. In some embodiments, the centrifuge system may further comprise a centrifuge container adapter sleeve configured to receive the centrifuge container adapter and to be received into the rotor cavity.

The centrifuge system may further comprise a centrifuge container. The centrifuge container may be configured to be received into the hollow region of the centrifuge container adapter. In some embodiments, the centrifuge system is configured such that when the centrifuge container is positioned in the centrifuge container adapter, the centrifuge container and the centrifuge container adapter define a void space configured to receive a fluid from a sample contained within the centrifuge container.

According to one or more embodiments, a series of methods are provided. In one or more embodiments a method for transferring fluid from a sample within a centrifuge container is disclosed.

The method may comprise inserting a centrifuge container comprising a sample comprising a fluid into a centrifuge container adapter configured to receive the centrifuge container. In some embodiments the received centrifuge container and the centrifuge container adapter define a void space.

The method may further comprise inserting the centrifuge container adapter into a rotor cavity of a centrifuge. In some embodiments, the method may further comprise inserting the centrifuge container adapter into a centrifuge container adapter sleeve and inserting the centrifuge container adapter sleeve into the rotor cavity.

The method may further comprise operating the centrifuge to transfer fluid from the sample within the centrifuge container into the void space.

Other aspects, uses, embodiments, and features of the centrifuge container adapters, systems, and methods will become apparent from the following detailed description when considered in conjunction with the accompanying drawings.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled or shown in every drawing. In the drawings:

FIG. 1 shows a perspective view of an exemplary centrifuge container adapter, according to one or more embodiments;

FIG. 2 shows a cross-sectional view of an exemplary centrifuge container adapter, according to one or more embodiments;

FIG. 3A shows a side view of an exemplary centrifuge container adapter, according to one or more embodiments;

FIG. 3B shows a side view of an exemplary centrifuge container, according to one or more embodiments;

FIG. 3C shows a perspective view of an exemplary centrifuge container adapter sleeve, according to one or more embodiments;

FIG. 4A shows a side view of an exemplary centrifuge container comprising a sample received into a centrifuge container adapter, prior to centrifuging, according to one or more embodiments;

FIG. 4B shows a side view of an exemplary centrifuge container comprising a sample received into a centrifuge container adapter, during or subsequent to centrifuging, according to one or more embodiments;

FIG. 5A shows an exploded view of an exemplary centrifuge system according to one or more embodiments; and

FIG. 5B shows an exploded view of an exemplary centrifuge system comprising a centrifuge container adapter sleeve according to one or more embodiments.

### DETAILED DESCRIPTION

The present disclosure generally provides centrifuge container adapters configured to be used in a centrifuge (e.g., a bench-top centrifuge), and related articles, centrifuge systems, and methods incorporating the centrifuge container adapters. The centrifuge container adapter may receive a centrifuge container. The centrifuge container may contain a sample, such as a packing column of porous media, comprising one or more fluids (e.g., aqueous solutions, such as water, or non-aqueous solutions, such as crude oil). During a centrifuging operation, according to some embodiments, the centrifuge container adapter and centrifuge container may be placed in a rotor cavity in the centrifuge. As the centrifuge's rotor spins, an amount of fluid from the sample may exit an aperture of the centrifuge container and be collected in the void space formed between the centrifuge container and the centrifuge container adapter. In some embodiments, measurements of the fluid within the centrifuge container adapter may be used to determine characteristics or properties of the sample.

Embodiments of the disclosed articles (e.g., centrifuge container adapter), methods, and systems (e.g., centrifuge system) offer advantages in operational costs, capital investment, and timeliness of results over other methods and systems that have been used to measure characteristics of a sample. For example, one or more embodiments of the present invention eliminates the need to use specially designed and expensive floor-standing centrifuges that have been used for certain applications, saving several hours or days of time in centrifuging operations.

According to one or more embodiments, a centrifuge system may comprise a centrifuge, a centrifuge container adapter, and a centrifuge container. The centrifuge may be a bench-top centrifuge. An example of a commercially available bench-top centrifuge includes the Allegra® X-22 Centrifuge, available from Beckman Coulter®. Examples of commercially available centrifuge containers include those available from Biotage®, such as Part Number SEC-0025.

The centrifuge may comprise a rotor configured to rotate around a central axis. The rotor may comprise a rotor cavity for receiving the centrifuge container adapter.

The centrifuge container adapter may be configured to be received into the rotor cavity. The centrifuge container adapter may have a hollow region.

The centrifuge container may be configured to be received into the hollow region of the centrifuge container adapter. When the centrifuge container is positioned in the centrifuge container adapter, the centrifuge container and the centrifuge container adapter may define a void space configured to receive fluid from a sample within the centrifuge container during operation of the centrifuge.

In some embodiments, the centrifuge system may further comprise a centrifuge container adapter sleeve configured to be received into the rotor cavity. In such embodiments, the centrifuge container adapter is configured to receive the centrifuge container which contains the sample. Examples of commercially available sleeves that may function as a centrifuge container adapter sleeve include those commercially available from Beckman Coulter®, such as Part Number 392255.

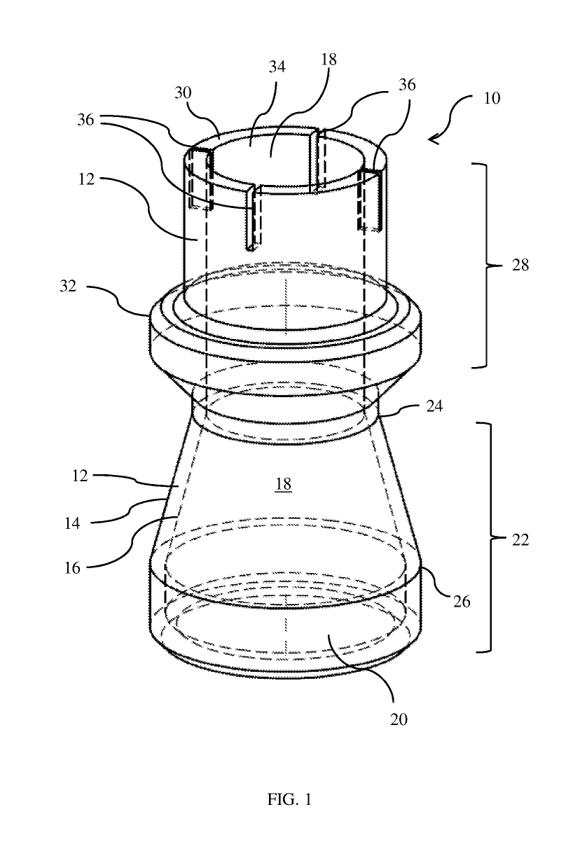

Turning to the figures, FIG. 1 shows a perspective view of an exemplary centrifuge container adapter 10, according to one or more embodiments. In FIG. 1 surfaces of the centrifuge container adapter 10 in the line of sight of a viewer from the given perspective are shown in solid line, while surfaces that would be hidden from the viewer are shown in dashed line.

The centrifuge container adapter may comprise a sidewall that together with a bottom end defines a hollow region of the centrifuge container adapter. The sidewall may be any suitable shape. For example, the sidewall may have an annular or cylindrical shape along a representative horizontal plane passed through it. Alternatively, the sidewall may be segmented and have a hexagonal, octagonal, or other shape, along a representative horizontal plane passed through it.

For example, in FIG. 1, the centrifuge container adapter 10, comprises a sidewall 12. The sidewall 12 may have an exterior surface 14 and an interior surface 16. The sidewall 12 and a bottom end 20 define a hollow region 18 spanning from the top end 30 through the bottom end 20 of the centrifuge container adapter 10, as shown. According to the embodiment shown in FIG. 1, the sidewall 12 has an annular or cylindrical shape along any horizontal plane passed through it.

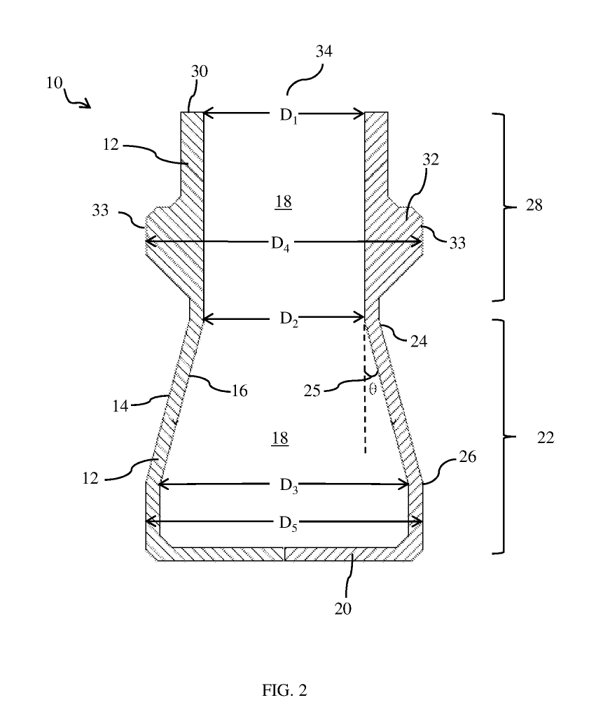

The sidewall may comprise different portions. For example, the sidewall may comprise a flared portion. In the flared portion, the diameter of the sidewall at its interior surface (e.g., inner diameters D₂ and D₃ of FIG. 2), as measured in a horizontal plane passing therethrough, may change along the vertical axis. (The term “diameter” has its customary meaning with regard to circular/annular shapes, and means the largest cross-sectional dimension for non-circular shapes (e.g., hexagons), for purposes of this disclosure, unless stated otherwise.) For example, according to some embodiments, the diameter of the sidewall may expand in the downward direction in the flared portion. The flared portion may have a narrow end (relative to a wide end) and a wide end (relative to the narrow end), the wide end having a larger diameter than the narrow end. In some embodiments, the narrow end may be positioned above the wide end. The sidewall may also comprise a vertical portion in which the diameter of the sidewall at its interior surface remains constant or substantially constant (i.e., out of vertical by 2° or less). In some embodiments, the vertical portion may be positioned above the flared portion.

Returning to the figures, FIG. 2 shows a cross-sectional view through a vertical plane passing through the center of the exemplary centrifuge container adapter 10 of FIG. 1, according to one or more embodiments. As shown in FIG. 2, the sidewall 12 may comprise a flared portion 22. In the flared portion 22, the sidewall 12 flares out at an angle 25, represented by θ, as shown. As a result, a narrow end 24 of the flared portion 22 has a smaller inner diameter D₂ than the inner diameter D₃ of the wide end 26 near the bottom end 20. The sidewall 12 may also comprise a vertical portion 28, which may be positioned above the flared portion 22. Because the interior surface 16 of the sidewall 12 is vertical or substantially vertical (i.e., out of vertical by 2° or less) in the vertical portion 28, the inner diameter D₁ at the top end 30 of the sidewall 12 is equal or substantially equal (e.g., differing by the length resulting from being out of vertical by 2° or less), to the inner diameter D₂ at the bottom of the vertical portion 28.

The centrifuge container adapter may further comprise a collar surrounding the sidewall. In some embodiments the collar is formed integrally with the sidewall. The outer surface of the collar may be circular or other shapes (e.g., hexagonal). The collar may function to add weight to the centrifuge container adapter and contribute to overall stability and balance of the centrifuge container adapter. Furthermore, the collar may have an outer diameter, as measured at its outer surface, that is equal or substantially equal (i.e., within 1%) to the outer diameter of the outer surface of the sidewall at the wide end of the flared portion or bottom end (e.g., outer diameter D₅ of FIG. 2). In such embodiments, this equality or similarity in the two outer diameters may contribute to a desired snug fit of the centrifuge container adapter in the rotary cavity of the centrifuge.

For example, as shown in FIGS. 1 and 2, the centrifuge container adapter 10 may comprise a collar 32, which surrounds, and is integral with, the sidewall 12. The collar 32 may be located along the vertical portion 28 of the centrifuge container adapter 10. The collar 32 may have an outer diameter D₄ measured at an outer surface 33, that is equal or substantially equal to the outer diameter D₅ of the sidewall 12 at the wide end 26 of the flared portion 22.

According to certain embodiments, a top end of the sidewall of the centrifuge container adapter may define an opening into the hollow region. On the opposite end of the centrifuge container adapter, there may be a bottom end. In some embodiments, the diameter of the bottom end of the centrifuge container adapter may be larger than a diameter of the opening of the centrifuge container adapter.

For example, in FIG. 2, the inner diameter D₃ near the bottom end 20 of the centrifuge container adapter 10 is larger than the inner diameter D₁ near the opening 34.

In some embodiments, the sidewall comprises at least one slit extending from the top end of the sidewall toward the bottom end. The slit(s) may extend from the top end of the sidewall toward the bottom end along the vertical portion. The slits may mate with fins of a centrifuge container to prevent rotation of the centrifuge container relative to the centrifuge container adapter to promote stability and support for the centrifuge container.

For example, returning to FIG. 1, in the embodiment shown, four slits 36 are present on the sidewall 12 near the opening 34 at the top end 30, with each slit 36 positioned apart from the other slits 36 and extending vertically from the top end 30 of the sidewall 12 toward the bottom end 20 along the vertical portion 28. The position of the slits 36 may be spread equally from each other as shown.

A centrifuge container may be configured to be received into the hollow region of the centrifuge container adapter. The centrifuge container may comprise a body. In some embodiments, the centrifuge container may comprise a cover joined to the body via a threaded connection, compression fitment, or any other means as understood by those of ordinary skill in the art. The cover may be sealed or removed from the body to allow for inserting or removing a sample from the body of the centrifuge container. A sample placed within the body of the centrifuge container may comprise one or more fluids (e.g., aqueous or non-aqueous solutions). The sample may further comprise porous media, through which the fluid may travel during centrifuging operations. Other suitable sample media or materials may also be used, as would be understood by a person of ordinary skill in the art. The centrifuge container may further comprise one or more apertures formed in the body and configured to allow fluid to pass through the body and exit through the aperture during operation of the centrifuge. For example, one or more apertures may be formed in the centrifuge container bottom end. The centrifuge container may comprise one or more fins configured to be mated with one or more slits of the centrifuge container adapter.

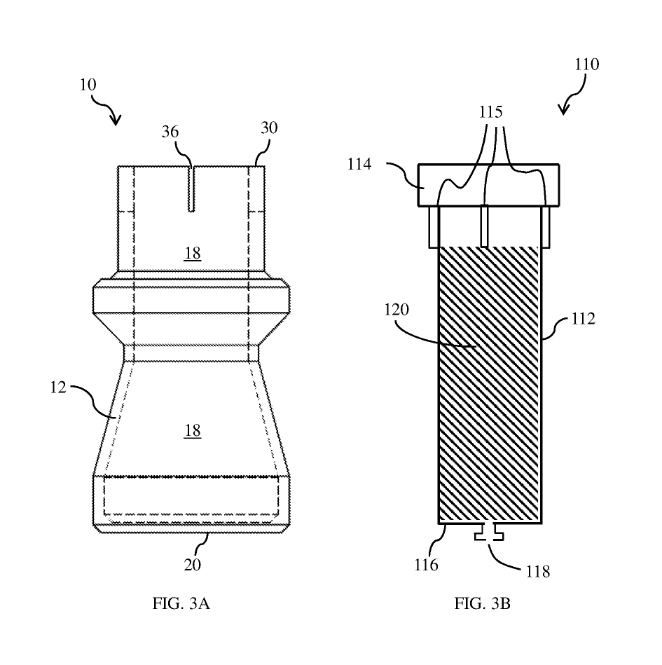

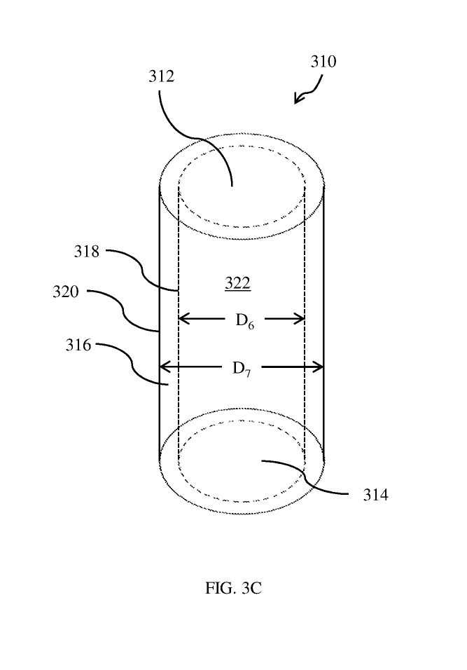

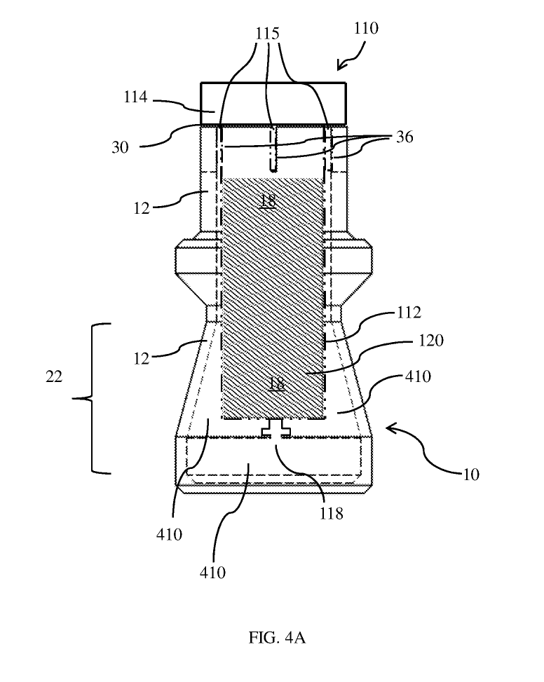

For example, turning to FIGS. 3A and 3B, FIG. 3A shows a side view of the exemplary centrifuge container adapter 10 of FIGS. 1 and 2, while FIG. 3B shows a side view of an exemplary centrifuge container 110 configured to be received into the centrifuge container adapter 10, according to one or more embodiments. The centrifuge container 110 is configured to be received into the hollow region 18 of the centrifuge container adapter 10.

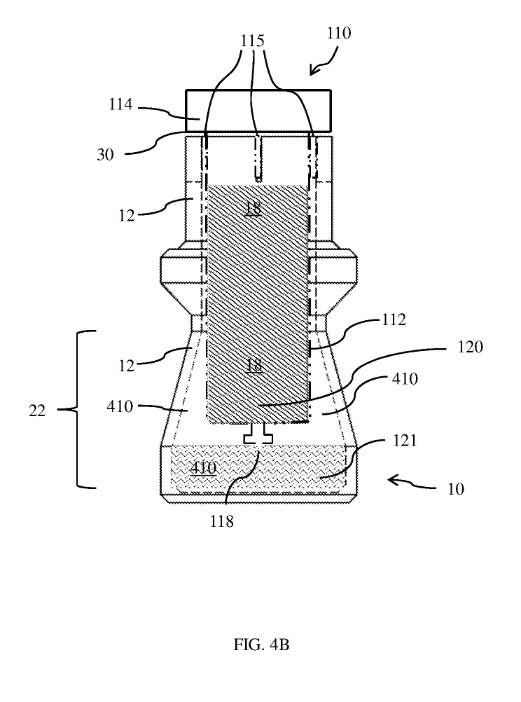

The centrifuge container 110 comprises a body 112 and a cover 114 joined to the body 112 via a threaded connection, compression fitment, or any other means of attachment as understood by those of ordinary skill in the art. The cover 114 may be sealed or removed from the body 112 to allow for inserting or removing the sample 120 from the body 112 of the centrifuge container 110. Sample 120 may be contained within the body 112. The sample 120 may comprise fluid 121 (e.g., an aqueous solution and possibly solids, such as suspended solids, or non-aqueous solutions, such as crude oil, or combinations thereof), as shown in FIG. 4B. The sample 120 may further comprise porous media (e.g., rocks, shale, cuttings, ceramics, alumina, sand, silica or combinations thereof) through which the fluid 121 may travel during centrifuging operations. Other suitable sample media or materials may also be used, as would be understood by a person of ordinary skill in the art. The centrifuge container 110 further comprises an aperture 118 formed in a centrifuge container bottom end 116 of the body 112 and configured to allow fluid 121 to pass through the body 112 and exit through the aperture 118 during operation of the centrifuge. The centrifuge container 110 further comprises one or more fins 115 configured to be mated with one or more slits 36 of the centrifuge container adapter 10, to provide support and stability for the centrifuge container 110.

According to some embodiments, the centrifuge system may further comprise an optional centrifuge container adapter sleeve configured to receive the centrifuge container adapter and to be received into the rotor cavity. The centrifuge container adapter sleeve may function to bridge a gap where there is a difference between the length of the outermost diameter of the centrifuge container adapter and the inner diameter of the rotor cavity of the centrifuge, so that the centrifuge container adapter is held snugly in the centrifuge.

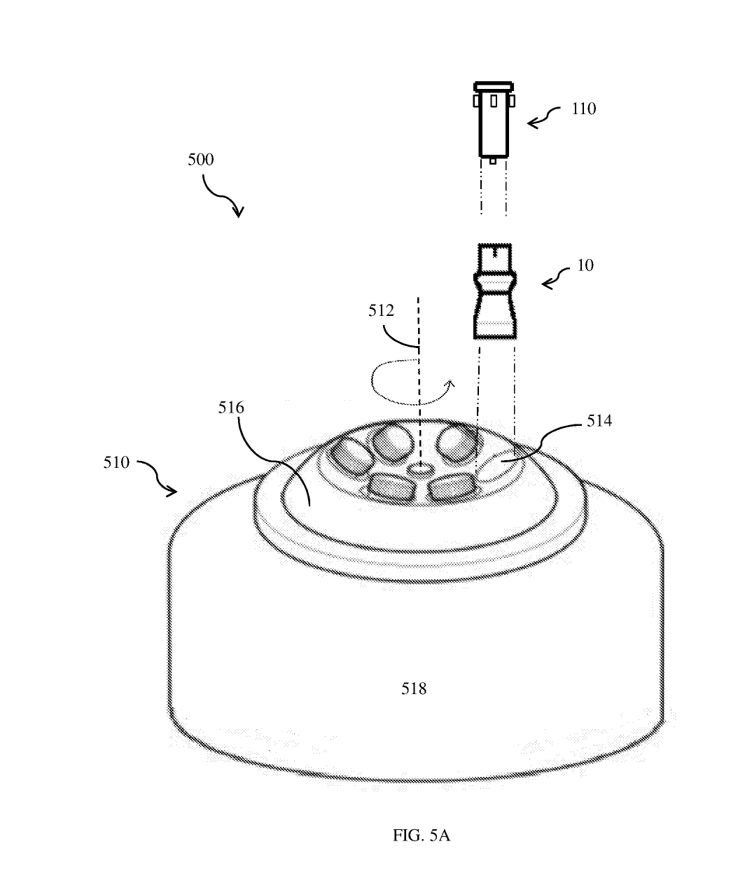

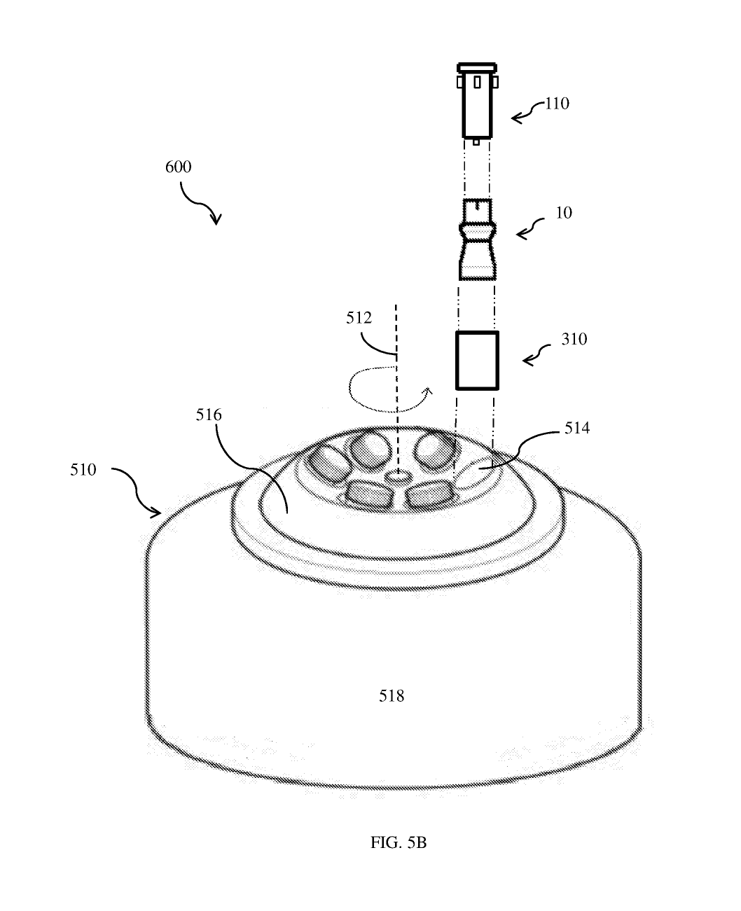

For example, FIG. 3C shows a perspective view of an exemplary centrifuge container adapter sleeve 310, according to one or more embodiments. The centrifuge container adapter sleeve 310 has a sleeve open top end 312, and a sleeve bottom end 314 that may be open or closed. The centrifuge container adapter sleeve 310 also comprises a sleeve sidewall 316 having a sleeve inner surface 318 and a sleeve outer surface 320. The sleeve sidewall 316 defines a sleeve hollow region 322 into which the centrifuge container adapter 10 may be inserted from the sleeve open top end 312. The centrifuge container adapter sleeve 310 may have an inner diameter D₆ defined as the diameter of the sleeve sidewall 316 at the sleeve inner surface 318. The inner diameter D₆ of the centrifuge container adapter sleeve 310 may be sized to fit the widest outer diameter of a centrifuge container adapter (e.g., D₄ or D₅ of the embodiment of a centrifuge container adapter 10 shown in FIG. 2). The outer diameter D₇ of the centrifuge container adapter sleeve 310 may be sized to fit a rotor cavity 514 of the centrifuge 510 to be used, as shown in FIG. 5B.

According to some embodiments, the cover of the centrifuge container may be configured to sit on the top end of the sidewall of the centrifuge container adapter when the centrifuge container is received into the centrifuge container adapter. According to some embodiments, the centrifuge container and the flared portion of the sidewall of the centrifuge container adapter define the void space configured to receive fluid from a sample contained in the centrifuge container during operation of the centrifuge.

For example, FIG. 4A shows a side view of the centrifuge container 110 of FIG. 3B received into the centrifuge container adapter 10 of FIG. 3A, according to one or more embodiments. In the embodiment shown in FIG. 4A, the centrifuge container 110 and the centrifuge container adapter 10 are shown prior to being subjected to centrifuge spinning, and therefore, fluid 121 (not shown) in the sample 120 of the centrifuge container 110 remains in the centrifuge container 110. In the embodiment shown in FIG. 4A, the cover 114 of the centrifuge container 110 sits on the top end 30 of the sidewall 12 of the centrifuge container adapter 10 and the fins 115 fit into the slits 36. Furthermore, the centrifuge container 110 and the flared portion 22 of the sidewall 12 of the centrifuge container adapter 10 define a void space 410 configured to receive fluid 121 (not shown) from the sample 120 contained inside the centrifuge container 110 during operation of the centrifuge.

FIG. 4B shows the embodiment of FIG. 4A during or after centrifuge spinning. As shown, fluid 121 has exited the centrifuge container 110 via aperture 118 and resides in the void space 410 defined between the body 112 of the centrifuge container 110 and the sidewall 12 of the centrifuge container adapter 10.

According to one or more embodiments, a centrifuge may be provided as part of a centrifuge system. The centrifuge may comprise a rotor configured to rotate around a central axis. The rotor may comprise a rotor cavity. The centrifuge container adapter may be configured to be received into the rotor cavity. In other embodiments, a centrifuge container adapter sleeve may be configured to be received into the rotor cavity.

For example, FIG. 5A shows an exploded view of an exemplary centrifuge system 500 according to one or more embodiments. In the embodiment shown in FIG. 5A, the centrifuge system comprises a centrifuge 510, the centrifuge container adapter 10, and the centrifuge container 110. The centrifuge 510 comprises a centrifuge body 518 and a rotor 516 that rotates around a central axis 512. The rotor 516 further comprises a rotor cavity 514. The centrifuge container adapter 10 may be configured to be received into the rotor cavity 514, and the centrifuge container 110 may be configured to be received into the centrifuge container adapter 10 (e.g., via the hollow region 18 shown in FIGS. 4A and 4B, for example).

FIG. 5B shows an exploded view of an exemplary centrifuge system 600 similar to the one shown in FIG. 5A. However, the centrifuge system 600 further comprises an optional centrifuge container adapter sleeve 310, like that shown in FIG. 3C. In the centrifuge system 600 shown in FIG. 5B, the rotor cavity 514 receives the centrifuge container adapter sleeve 310, which in turn receives the centrifuge container adapter 10, which in turn receives the centrifuge container 110.

According to one or more embodiments, the dimensions of various aspects of components of the system may be chosen with other components in mind, and may be selected accordingly as would be understood by a person of ordinary skill in the art. For example, the overall dimensions of the centrifuge container adapter may be chosen in view of the dimensions of rotor cavities of a centrifuge, or vice versa. Likewise, the hollow region of the centrifuge container adapter may be sized to hold a particular centrifuge container, or vice versa. Likewise, the dimensions of (or decision to incorporate) a centrifuge container adapter sleeve may be chosen in view of the dimensions of a rotor cavity and/or centrifuge container adapter.

In some embodiments, the centrifuge container adapter may have a particular height, as measured from a bottom end to a top end. The centrifuge container adapter may have a height of at least 2 inches, at least 3 inches, at least 4 inches, at least 5 inches, at least 6 inches, at least 7 inches, at least 8 inches, or at least 9 inches. The centrifuge container adapter may have a height of less than or equal to 10 inches, less than or equal to 9 inches, less than or equal to 8 inches, less than or equal to 7 inches, less than or equal to 6 inches, less than or equal to 5 inches, less than or equal to 4 inches, less than or equal to 3 inches, or less than or equal to 2 inches. The above ranges may also be combined (e.g., a height of at least 4 inches and less than or equal to 6 inches). Other values are also possible.

In some embodiments, the vertical portion of the centrifuge container adapter may have a particular inner diameter, as represented, for example, by D₁ in FIG. 2. The inner diameter may be at least 0.1 inches, at least 0.25 inches, at least 0.5 inches, at least 1 inch, at least 1.5 inches, at least 2 inches, at least 2.5 inches, at least 3 inches, or at least 4 inches. The inner diameter may be less than or equal to 5 inches, less than or equal to 4 inches, less than or equal to 3 inches, less than or equal to 2.5 inches, less than or equal to 2 inches, less than or equal to 1 inch, less than or equal to 0.5 inches, or less than or equal to 0.25 inches. The above ranges may also be combined (e.g., an inner diameter of at least 0.5 inches and less than or equal to 1 inch). Other values are also possible.

In some embodiments, the wide end of the flared portion of the centrifuge container adapter may have a particular inner diameter, as represented, for example, by D₃ in FIG. 2. The inner diameter may be at least 0.1 inches, at least 0.25 inches, at least 0.5 inches, at least 1 inch, at least 1.5 inches, at least 2 inches, at least 2.5 inches, at least 3 inches, or at least 4 inches. The inner diameter may be less than or equal to 5 inches, less than or equal to 4 inches, less than or equal to 3 inches, less than or equal to 2.5 inches, less than or equal to 2 inches, less than or equal to 1 inch, less than or equal to 0.5 inches, or less than or equal to 0.25 inches. The above ranges may also be combined (e.g., an inner diameter at the wide end of at least 0.5 inches and less than or equal to 1 inch). Other values are also possible.

In some embodiments the flared portion of the centrifuge container adapter may have a particular angle of deviation from the vertical, as represented, for example, by θ in FIG. 2. The angle may be at least 2°, at least 10°, at least 20°, at least 30°, at least 40°, at least 50°, or at least 60°. The angle may be less than or equal to 70°, less than or equal to 60°, less than or equal to 50°, less than or equal to 40°, less than or equal to 30°, less than or equal to 20°, or less than or equal to 10°. The above ranges may also be combined (e.g., an angle of at least 10° and less than or equal 20°). Other values are also possible.

In some embodiments, there may be a particular ratio of the height of the flared portion to the overall height of the centrifuge container adapter. The ratio may be at least 1:5, at least 1:4, at least 1:3, at least 1:2, at least 2:3, or at least 3:4. The ratio may be less than or equal to 4:5, less than or equal to 3:4, less than or equal to 2:3, less than or equal to 1:2, or less than or equal to 1:3. The above ranges may also be combined (e.g., a ratio of at least 1:4 and less than or equal 1:2). Other values are also possible.

In some embodiments, there may be a particular ratio of the height of the vertical portion to overall height of the centrifuge container adapter. The ratio may be at least 1:5, at least 1:4, at least 1:3, at least 1:2, at least 2:3, or at least 3:4. The ratio may be less than or equal to 4:5, less than or equal to 3:4, less than or equal to 2:3, less than or equal to 1:2, or less than or equal to 1:3. The above ranges may also be combined (e.g., a ratio of at least 1:4 and less than or equal 1:2). Other values are also possible.

In some embodiments, there may be a particular ratio of the height of the center of where the collar is located to the overall height of the centrifuge container adapter. The ratio may be at least 1:5, at least 1:4, at least 1:3, at least 1:2, at least 2:3, or at least 3:4. The ratio may be less than or equal to 4:5, less than or equal to 3:4, less than or equal to 2:3, less than or equal to 1:2, or less than or equal to 1:3. The above ranges may also be combined (e.g., a ratio of at least 1:2 and less than or equal 4:5). Other values are also possible.

According to one or more embodiments, the centrifuge may comprise a bench-top centrifuge (e.g., centrifuge 510 of FIGS. 5A and 5B). A commercially available centrifuge may be used. An example of a commercially available bench-top centrifuge includes the Allegra® X-22 Centrifuge, available from Beckman Coulter®. While there are no precise dimensions for what constitutes a bench-top centrifuge, a bench-top centrifuge may be considered a centrifuge small enough in size to rest on a normal-sized bench-top under conditions of normal use, as would be understood by a person of ordinary skill in the art. A bench-top centrifuge may be distinguished from, for example, a floor-standing centrifuge, which would be incapable or impracticable to rest on a normal-sized bench-top. A bench-top centrifuge may have the advantage of being easier and less expensive to operate than a floor-standing centrifuge.

The centrifuge container adapter may be formed from a variety of materials, including, without limitation, steel, aluminum, Teflon®, titanium, polymers, and various alloys, and in some embodiments may be machined from a single block of material. In a preferred embodiment, the centrifuge container adapter comprises aluminum. In choosing a material, characteristics such as weight, durability, and cost may be taken into consideration. For example, aluminum, which is a relatively lightweight and inexpensive metal, may be used in embodiments where the combined weight of the centrifuge container adapter and collected fluid is to be kept under the maximum capacity of an analytic scale used to measure their combined weight. The centrifuge container adapter may be fabricated according to any method deemed appropriate by a person of ordinary skill in the art.

The centrifuge container may also be made from any material deemed fit by a person of ordinary skill in the art. For example, it may be made from a plastic or other material. The centrifuge container may be fabricated according to any method deemed appropriate by a person of ordinary skill in the art. Commercially available centrifuge containers may be used. Examples of commercially available centrifuge containers include those available from Biotage®, such as Part Number SEC-0025.

According to one or more embodiments, a series of methods are provided. In one or more embodiments a method for transferring fluid from a sample contained inside a centrifuge container is disclosed.

The method may comprise inserting a centrifuge container comprising a sample that includes fluid into a centrifuge container adapter configured to receive the centrifuge container. In some embodiments, the received centrifuge container and the centrifuge container adapter define a void space. The method may further comprise inserting the centrifuge container adapter into a rotor cavity of a centrifuge. The method may further comprise operating the centrifuge to transfer fluid from the sample within the centrifuge container into the void space. Examples of components that may be incorporated into such a method have been discussed above with reference to FIGS. 1-5B.

According to one or more embodiments, after centrifuging operation, the method may further comprise removing the centrifuge container from the centrifuge container adapter while leaving the transferred fluid in the void space of the centrifuge container adapter for further analysis. According to one or more embodiments, the sample contained in the centrifuge container may further comprise porous media, such as sand, shale, cuttings, ceramics, alumina, rocks, silica, etc.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language, such as “comprising,” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element or a list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A centrifuge container adapter configured to be received into a centrifuge, the centrifuge container adapter comprising:
a sidewall comprising a flared portion and a vertical portion, wherein the vertical portion is located above the flared portion;
a bottom end, wherein the sidewall and the bottom end define a hollow region;
a top end, at which the sidewall further defines an opening of the hollow region; and
a collar surrounding the vertical portion of the sidewall.

2. The centrifuge container adapter of claim 1, wherein an outer diameter of the collar is substantially equal to an outer diameter of the bottom end.

3. The centrifuge container adapter of claim 1, wherein the collar is formed integrally with the sidewall.

4. The centrifuge container adapter of claim 1, wherein the flared portion has a narrow end and a wide end, the wide end having a larger diameter than the narrow end.

5. The centrifuge container adapter of claim 4, wherein the narrow end of the flared portion is proximate the vertical portion.

6. The centrifuge container adapter of claim 4, wherein an inner diameter of the wide end of the flared portion is larger than an inner diameter of the opening of the hollow region.

7. The centrifuge container adapter of claim 1, wherein an inner diameter of the vertical portion is substantially uniform throughout the vertical portion.

8. The centrifuge container adapter of claim 1, wherein an interior surface of the sidewall in the vertical portion is cylindrical.

9. The centrifuge container adapter of claim 1, wherein the sidewall comprises at least one slit extending vertically from the top end of the sidewall toward the bottom end along the vertical portion.

10. The centrifuge container adapter of claim 1, wherein the collar is positioned along the vertical portion.

11. The centrifuge container adapter of claim 1, wherein the centrifuge container adapter is machined from a single block of material.

12. The centrifuge container adapter of claim 1, wherein the centrifuge adapter comprises aluminum.

13. A centrifuge system, comprising:
a centrifuge comprising a rotor configured to rotate around a central axis, the rotor comprising a rotor cavity;
a centrifuge container adapter configured to be received into the rotor cavity, the centrifuge container adapter having a hollow region; and
a centrifuge container configured to be received into the hollow region of the centrifuge container adapter, wherein when the centrifuge container is positioned in the centrifuge container adapter, the centrifuge container and the centrifuge container adapter define a void space configured to receive a fluid from a sample contained within the centrifuge container.

14. The centrifuge system of claim 13, further comprising a centrifuge container adapter sleeve configured to receive the centrifuge container adapter and to be received into the rotor cavity.

15. The centrifuge system of claim 13, wherein the centrifuge comprises a bench-top centrifuge.

16. The centrifuge system of claim 13, wherein the centrifuge container adapter further comprises a sidewall defining a flared portion, and wherein the flared portion and the centrifuge container further define the void space.

17. The centrifuge system of claim 16, wherein the centrifuge container comprises a cover joined to a body of the centrifuge container, wherein the cover is configured to sit on a top end of the sidewall of the centrifuge container adapter when the centrifuge container is received into the centrifuge container adapter.

18. The centrifuge system of claim 17, wherein the centrifuge container comprises one or more apertures formed in the body.

19. The centrifuge system of claim 18, wherein the centrifuge container comprises at least one fin configured to be mated with at least one slit of the sidewall of the centrifuge container adapter.
